(19) United States
(12) Patent Application Publication
(10) Pub. No.: US 2001/0017582 A1
(43) Pub. Date: Aug. 30, 2001

(54) Multilayer inductor

(76) Inventor: Keiji Sakata, Sabae-shi (JP)

Correspondence Address: Keating & Bennett LLP, Suite 312, 10400 Eaton Place, Fairfax, VA, 22030, US

(21) Appl. No.: 09/782,792

(22) Filed: Feb. 14, 2001

(30) Foreign Application Priority Data
Feb. 14, 2000 (JP) 2000-035593

(51) Int. Cl. H01F 5/00

(52) U.S. Cl. 336/200

(57) ABSTRACT

A multilayer inductor in which a DC resistance is small so that a high direct current can be applied thereto, has a structure in which a plurality of magnetic layers is stacked and coil conductor patterns are provided between the magnetic layers. The coil conductor patterns are spirally connected to each other via through-holes formed in the magnetic layers. The coil conductor patterns are arranged such that the areas of projected planes of the coil conductor patterns on main surfaces of the magnetic layers are within a range from about 35% to about 75% of the areas of the main surfaces of the magnetic layers.

### BACKGROUND OF THE INVENTION 1. Field of the Invention

The present invention relates to multilayer inductors. More particularly, the present invention relates to multilayer inductors such as choke coils for DC/DC converters.

2. Description of the Related Art

In a DC/DC converter used for a main power source of a personal computer, it is necessary to provide a coil or an inductor having a small DC resistance such that a high direct current can be applied thereto. Conventionally, these inductors are defined by winding drum-shaped cores with conductive wires.

FIG. 10 illustrates an example of a conventional inductor. In the inductor 1 shown in FIG. 10, a drum-shaped core 2 having a circular cross-section is wound with a conductive wire 3.

FIG. 11 illustrates another example of a conventional inductor. In the inductor 1 shown in FIG. 11, a drum-shaped core 2 having a rectangular cross-section is wound with a conductive wire 3.

FIG. 12 illustrates another example of a conventional inductor. In the inductor 1 shown in FIG. 12, a drum-shaped core 2 having a rectangular cross-section is wound with a conductive wire 3. In addition, an air gap or a cavity 4 is provided in the center of the core 2, that is, in the central portion of a coil defined by the conductive wire 3.

In the inductor 1 shown in FIG. 11, unlike the inductor 1 shown in FIG. 10, the conductive wire 3 has a rectangular cross section. As a result, since the entire space where the conductive wire 3 is wound is effectually used with no clearance or gaps, the DC resistance is reduced and a high direct current is thereby applied to the inductor.

Additionally, unlike the inductor 1 shown in FIG. 11, in the inductor 1 shown in FIG. 12, the air gap or the cavity 4 is provided in the center of the core 2, that is, in the central part of the coil defined by the conductive wire 3 such that a magnetic flux is cut off. With this arrangement, the DC application characteristics of inductance are improved.

However, in the inductor 1 shown in each of FIGS. 10 to 12, it is impossible to simultaneously produce the core 2 which is made of ferrite and the inside wire 3. In this case, for example, an E-shaped core is wound with a conductive wire, on which another E-shaped core is disposed. Thus, the cores are not in close surface-contact with each other, thereby causing characteristic deterioration and variations. Furthermore, the process for manufacturing the core is complicated. Additionally, since the cores are molded and the conductive wire having a rectangular cross section is expensive, production costs increase.

To overcome the above-described problems, other conventional inductors have been made. For example, multilayer inductors are disclosed in Japanese Unexamined Patent Application Publication No. 10-12443 and Japanese Unexamined Patent Application Publication No. 10-27712.

FIG. 13 illustrates an example of a conventional multilayer inductor. A multilayer inductor 5 shown in FIG. 13 includes a multilayer structure 6. The multilayer structure 6 includes a plurality of stacked magnetic layers 6a, between which coil conductor patterns 7 are provided. The coil conductor patterns 7 are spirally connected to each other via through-holes provided in the magnetic layers 6a. In addition, external electrodes 8a and 8b are provided at the ends of the multilayer structure 6. The external electrodes 8a and 8b are connected to the ends of a coil defined by the coil conductor patterns 7. Furthermore, to improve the DC application characteristics of inductance, a cavity 9a is provided in the center of the multilayer structure 6 or the magnetic layers 6a, that is, in the central portion of the coil.

FIG. 14 illustrates another example of a conventional multilayer inductor. In a multilayer inductor 5 shown in FIG. 14, unlike the inductor 5 shown in FIG. 13, the center of the multilayer structure 6 or the magnetic layers 6a, that is, the central portion of the coil is formed of a nonmagnetic ceramic 9b.

In the multilayer inductor 5 shown in each of FIGS. 13 and 14, in contrast with the inductors 1 shown in FIGS. 10 to 12, manufacturing is simplified such that production costs are reduced.

In the above-described conventional multilayer inductors, however, since the areas of coil conductor patterns are reduced, the DC resistance is increased. As a result, it is impossible to apply high direct currents to the inductors.

### SUMMARY OF THE INVENTION

To overcome the above-described problems with the prior art, preferred embodiments of the present invention provide a multilayer inductor having a greatly reduced DC resistance such that a high direct current can be applied thereto.

According to one preferred embodiment of the present invention, a multilayer inductor includes a plurality of stacked magnetic layers, through-holes provided in the magnetic layers, and a plurality of coil conductor patterns disposed between the plurality of magnetic layers and spirally connected to each other via the through-holes. In this multilayer inductor, the area of a projected plane of a circuit of each coil conductor pattern on a main surface of each of the magnetic layers is in a range from about 35% to about 75% of the area of the main surface of the magnetic layer.

In addition, in this multilayer inductor, a nonmagnetic portion is provided in the vicinity of the coil conductor patterns in the magnetic layer.

In the multilayer inductor according to various preferred embodiments of the present invention, the area of the projected plane of a circuit of each coil conductor pattern preferably ranges from about 35% to about 75% of the area of the main surface of each magnetic layer. With this arrangement, DC resistance of the coil defined by the plurality of coil conductor patterns is greatly reduced, and accordingly, a greatly increased direct current can be applied to the coil.

Furthermore, in the above-described multilayer inductor, the nonmagnetic portion is provided in the vicinity of the coil conductor patterns in the magnetic layer. As a result, a magnetic flux is cut off at the nonmagnetic portion. Thus, since magnetic saturation does not occur near the coil defined by the plurality of coil conductor patterns, the DC application characteristics of inductance are greatly improved.

Other features, steps, processes, characteristics, and advantages of the present invention will become more apparent from the detailed description of preferred embodiments with reference to the attached drawings.

### BRIEF DESCRIPTION OF THE DRAWINGS

FIG. 1 illustrates a multilayer inductor according to a preferred embodiment of the present invention.

FIG. 2 is an exploded perspective view of the multilayer inductor shown in FIG. 1.

FIG. 3 is a plan view showing a main surface of each magnetic layer and a projected plane of each coil conductor pattern of the multilayer inductor shown in FIG. 1.

FIG. 4 is a perspective view showing another configuration of magnetic layers and coil conductor patterns.

FIG. 5 is a graph showing electrical characteristics of a multilayer inductor using the magnetic layers and the coil conductor patterns shown in FIG. 4.

FIG. 6 illustrates a multilayer inductor according to another preferred embodiment of the present invention;

FIG. 7 is an exploded perspective view of the multilayer inductor shown in FIG. 6.

FIG. 8 is a graph showing electrical characteristics of the multilayer inductor obtained where no cavity is provided, where a cavity is formed, and where the cavity size is increased.

FIG. 9 is an exploded perspective view of a multilayer inductor according to another preferred embodiment of the present invention.

FIG. 10 illustrates a conventional inductor.

FIG. 11 illustrates another conventional inductor.

FIG. 12 illustrates another conventional inductor.

FIG. 13 illustrates another conventional inductor.

FIG. 14 illustrates another conventional inductor.

### DETAILED DESCRIPTION OF PREFERRED EMBODIMENTS

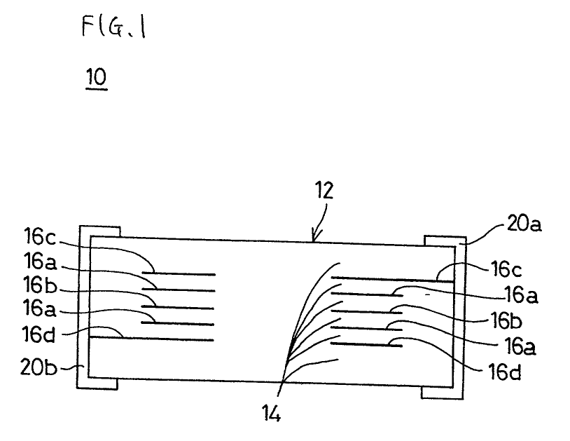

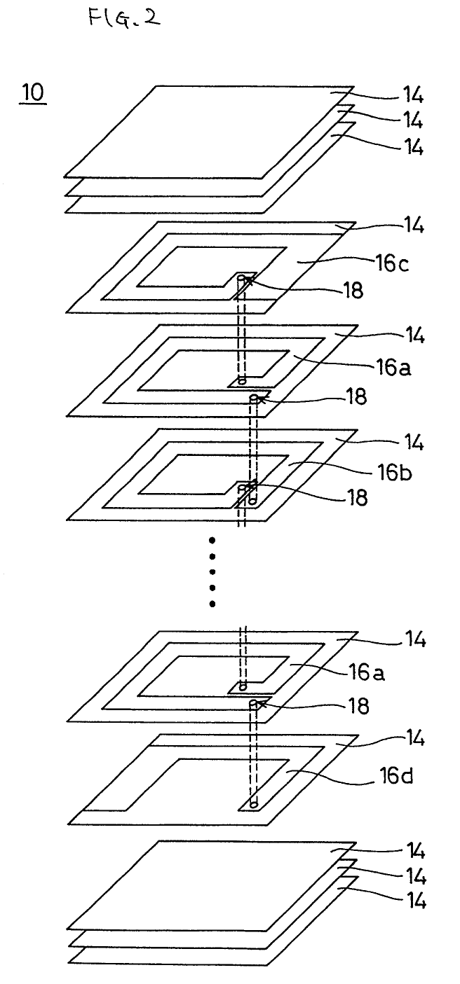

FIG. 1 illustrates a multilayer inductor according to a preferred embodiment of the present invention. FIG. 2 is an exploded perspective view thereof. A multilayer inductor 10 shown in each of FIGS. 1 and 2 includes a multilayer structure 12.

The multilayer structure 12 includes a plurality of stacked magnetic layers 14. Between the magnetic layers 14 first coil conductor patterns 16a, second coil conductor patterns 16b, and lead-out coil conductor patterns 16c and 16d are provided. In this case, the plurality of first coil conductor patterns 16aand the plurality of second conductor patterns 16b are alternately provided. In FIGS. 1 and 2, some of the plurality of first coil conductor patterns 16aand the plurality of second conductor patterns 16b are not shown to avoid repetition. The lead-out coil conductor pattern 16c is provided on the top of the first and second coil conductor patterns 16aand 16b. The lead-out coil conductor pattern 16d is provided thereunder. The lead-out coil conductor pattern 16c has a lead-out portion extending to one end of the magnetic layer 14. In addition, the other lead-out coil conductor pattern 16d has a lead-out portion extending to the other end of the magnetic layer 14. Furthermore, through-holes 18 are provided in the magnetic layers 14 disposed between the lead-out coil conductor patterns 16c and 16d. The coil conductor patterns 16a, 16b, 16c, and 16d are spirally connected to each other via the through-holes 18.

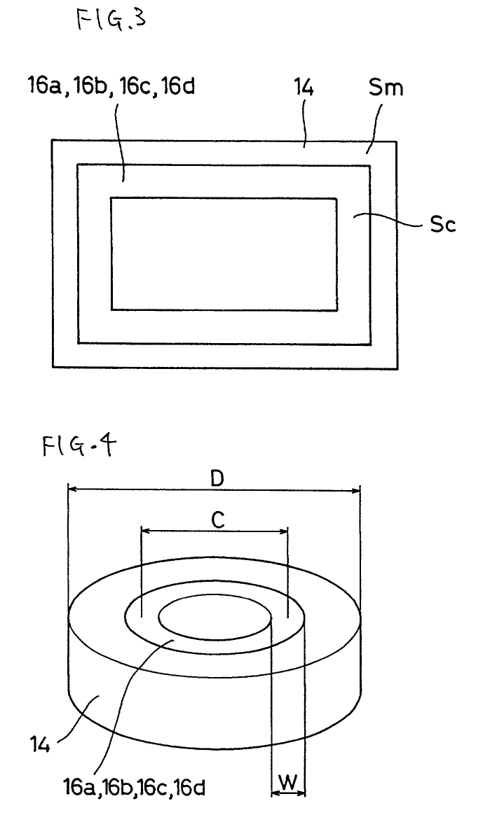

In the multilayer inductor 10, as shown in FIG. 3, the coil conductor patterns 16a, 16b, 16c, and 16d are provided such that the area Sc of a projected plane of a circuit on a main surface of each magnetic layer 14 ranges from about 35% to about 75% of the area Sm of the main surface of the magnetic layer 14.

Furthermore, external electrodes 20a and 20b are provided on the ends of the multilayer structure 12. The external electrodes 20a and 20b are connected to the lead-out portions of the coil conductor patterns 16c and 16d, that is, to the ends of a coil defined by the coil conductor patterns 16a, 16b, 16c, and 16d.

To manufacture the multilayer inductor 10, for example, first, each coil conductor pattern is printed on a green sheet used as each magnetic layer, by a method such as screen printing. Then, after alternately stacking green sheets having the first coil conductor patterns provided thereon and green sheets having the second coil conductor patterns provided thereon, green sheets having the lead-out coil conductor patterns provided thereon are disposed on the top of the stacked sheets and at the bottom thereof. Next, on the top of the entire stacked sheets and at the bottom thereof, further green sheets are provided to produce a multilayer structure. After the multilayer structure is pressed and fired, the external electrodes are disposed thereon to produce the multilayer inductor 10.

In the multilayer inductor 10, the area Sc of the projected plane of the circuit of the coil conductor patterns 16a, 16b, 16c, and 16d is preferably within the range of about 35% to about 75% of the area Sm of the main surface of the magnetic layers 14. As a result, DC resistance of the coil formed by the coil conductor patterns 16a, 16b, 16c, and 16d is greatly reduced and a high direct current is applied thereto.

When the ratio of the area Sc of the projected plane of each coil conductor pattern with respect to the area Sm of the main surface of each magnetic layer is less than about 35%, the DC resistance of the coil is increased, which is not preferable. On the other hand, when the area ratio of the same is more than about 75%, a magnetic flux does not pass through the coil, with the result that the obtained inductance is undesirably reduced.

Since the multilayer inductor 10 can be manufactured by the above-described stacking method, the process for manufacturing is not so complicated as that for manufacturing inductors obtained by winding wires, and cost of production is thereby greatly reduced.

Furthermore, the multilayer inductor 10 manufactured by integrating the components can be easily made thinner.

Now, a description will be provided of the electrical characteristics of the above multilayer inductor 10. In this case, the multilayer inductor 10 preferably includes disk-shaped magnetic layers 14, and coil conductor patterns 16a, 16b, 16c, and 16d having a substantially ring-shaped projected plane of the circuit of the coil conductor patterns on the main surfaces of the magnetic layers 14.

For example, as shown in FIG. 4, the diameter D of each disk-shaped magnetic layer 14 is preferably about 4 mm. In addition, in each of the coil conductor patterns 16a, 16b, 16c and 16d, a center section C in the width direction of the projected plane of the circuit of the conductor pattern has a substantially circular with a diameter of about 2 mm in length. The width W of each of the coil conductor patterns 16a, 16b, 16c, and 16d is preferably about 1 mm. In this case, the area of the main surface of each magnetic layer is approximately 12.56 mm, and the area of the projected plane of a circuit of each of the coil conductor patterns 16a, 16b, 16c, and 16d is approximately 6.28 mm². Thus, the ratio of the area of the projected plane thereof with respect to the area of the main surface of the magnetic layer 14 is about 50%.

In this example, when a multilayer inductor having a height or a thickness of about 1 mm is manufactured, with respect to an inductance of 10 μH, the value of a DC resistance is approximately 0.2 Ω.

In addition, when the width W of the coil conductor pattern is about 0.3 mm, the area ratio is about 15%. In this case, the necessary number of turns of the coil conductor pattern to obtain the same inductance of 10 μH is reduced, and the obtainable maximum inductance is much larger. A DC resistance with respect to the inductance of 10 μH is increased to be approximately 0.4 Ω.

Table 1 shows the value of a DC resistance with respect to each inductance obtained when the width W of the coil conductor pattern is changed in the above example.

TABLE 1

| ELECTRODE WIDTH (mm) | | 0.3 | 0.5 | 0.7 | 1.0 | 1.2 | 1.5 |
|---|---|---|---|---|---|---|---|
| AREA RATIO (%) | | 15 | 25 | 35 | 50 | 60 | 75 |
| DC | 5 μH | 0.25 | 0.18 | 0.14 | 0.12 | 0.11 | 0.11 |
| RESISTANCE | 10 μH | 0.39 | 0.28 | 0.22 | 0.20 | 0.19 | 0.18 |
| (Ω) | 20 μH | 0.57 | 0.41 | 0.33 | 0.30 | 0.29 | — |
| | 30 μH | 0.80 | 0.56 | 0.44 | — | — | — |
| | 50 μH | 1.04 | 0.82 | — | — | — | — |

Segments which have no DC resistance value in the Table 1 indicate cases in which the values are not available.

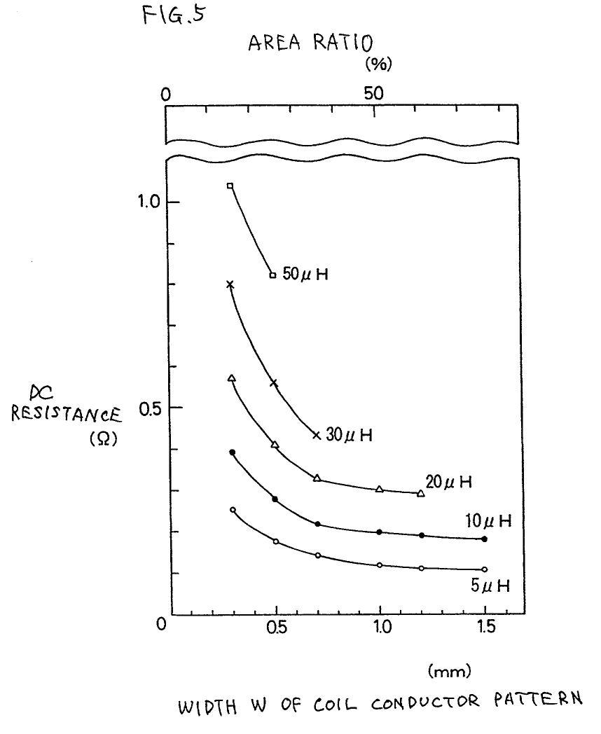

FIG. 5 is a graph for illustrating the content of Table 1. In Table 1 and the graph shown in FIG. 5, obviously, when the width W of the coil conductor pattern is increased, the DC resistance is reduced. However, the reduction ratio becomes gradually smaller, and the effects due to increases in the area ratio are reduced. In addition, each obtainable maximum inductance is reduced.

Furthermore, increasing the width W of the coil conductor pattern allows the DC resistance to be smaller. However, in the above example, when considering the range of obtainable inductance, in a range between about 5 μH and about 30 μH, the obtainable area ratio is preferably about 35% or greater.

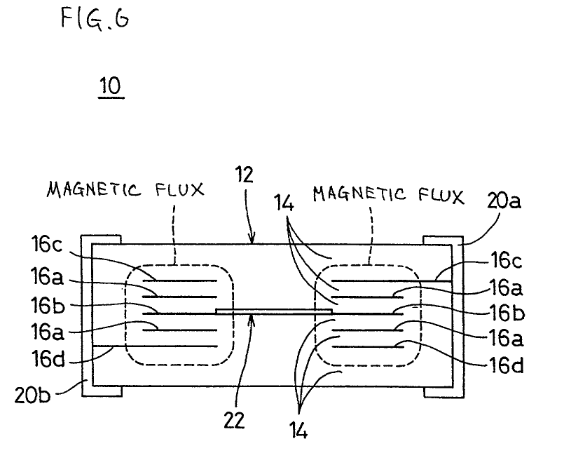

FIG. 6 illustrates a multilayer inductor according to another preferred embodiment of the present invention. FIG. 7 is an exploded perspective view of the multilayer inductor. In a multilayer inductor 10 shown in each of FIGS. 6 and 7, unlike the multilayer inductor 10 shown in each of FIGS. 1 and 2, an air gap or a cavity 22 is disposed inside a single second coil conductor pattern 16b.

The multilayer inductor 10 shown in each of FIGS. 6 and 7 is preferably manufactured in the same way as the multilayer inductor 10 shown in each of FIGS. 1 and 2 is manufactured. However, when the cavity 22 is formed, for example, after an organic paste such as carbon is thinly applied inside the second coil conductor pattern on a green sheet, the entire structure is fired.

In the multilayer inductor 10 shown in each of FIGS. 6 and 7, unlike the multilayer inductor 10 shown in each of FIGS. 1 and 2, particularly, since the cavity 22 cuts off a magnetic flux passing through the approximate center of the coil, magnetic saturation hardly occurs at the approximate center of the coil. As a result, good DC application characteristics of inductance can be obtained.

The size and position of the cavity 22 can be easily changed by changing the thickness of the applied organic paste and the position in which the organic paste is applied. With this arrangement, required characteristics can be obtained.

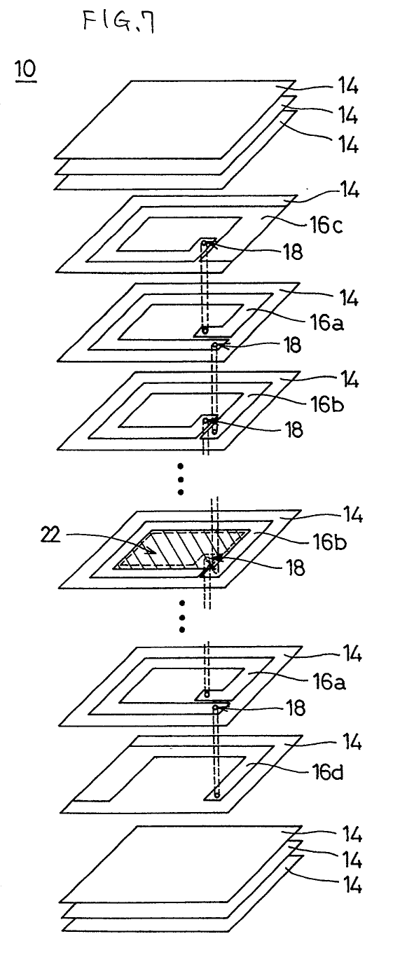

FIG. 8 is a graph showing the electrical characteristics of the multilayer inductor obtained when no cavity is formed, when a cavity is formed, and when the size of the cavity is increased. As evident in the graph shown in FIG. 8, DC application characteristics obtained when the cavity is formed are better than those obtained when no cavity is formed. Furthermore, it is seen that when the size of the cavity is increased, the inductance DC application characteristics of the multilayer inductor are even more improved.

Instead of forming the cavity 22 by applying an organic paste, when a resin sheet having the same size as that of the area where the organic paste is applied is disposed, this is equivalent to a situation in which a nonmagnetic part is formed in the vicinity of the coil conductor patterns. Thus, the magnetic flux is cut off at the nonmagnetic part. As a result, since magnetic saturation hardly occurs near the coil, the DC application characteristics of inductance are greatly improved.

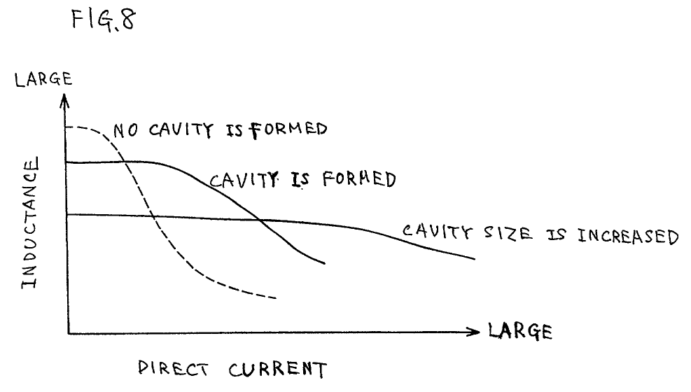

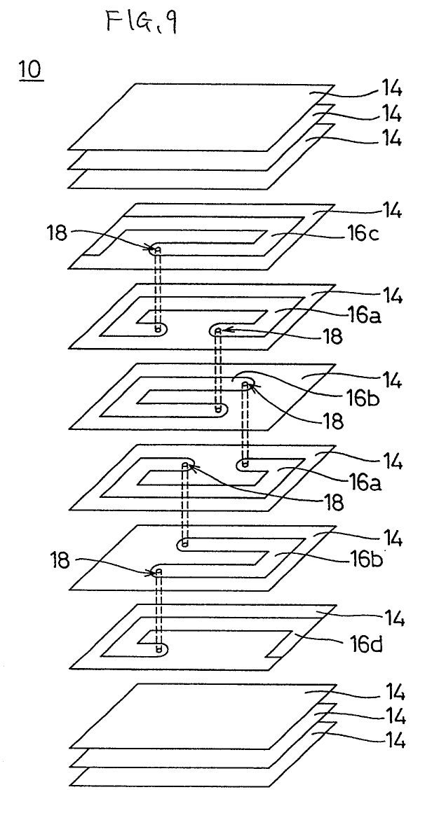

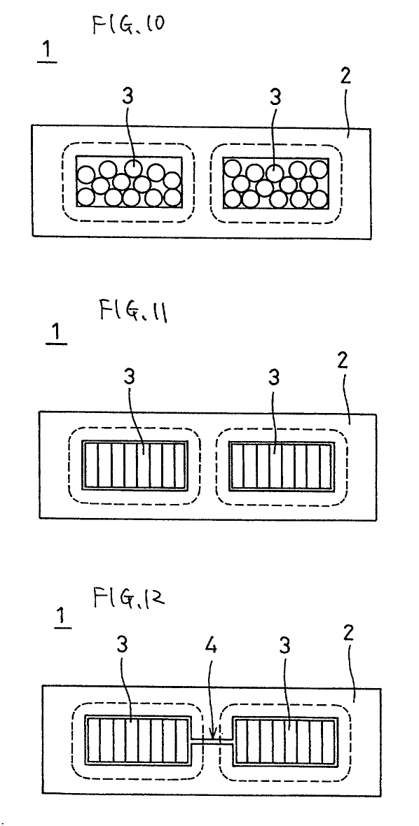

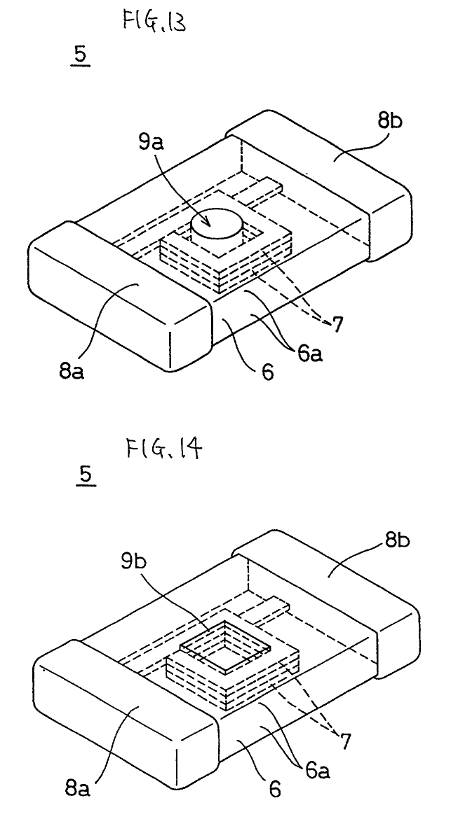

FIG. 9 is an exploded perspective view of a multilayer inductor according to another preferred embodiment of the present invention. Unlike the multilayer inductor 10 shown in each of FIGS. 1 and 2, in a multilayer inductor 10 shown in FIG. 9, particularly, first and second coil conductor patterns 16a and 16b have substantially C-shaped configurations, and lead-out coil conductor patterns 16c and 16d have substantially J-shaped configurations. As shown here, even with coil conductor patterns having different configurations, the same advantages can be obtained.

As described above, in the multilayer inductor according to various preferred embodiments the present invention, since the DC resistance is small, a high direct current can be applied thereto.

Furthermore, in the multilayer inductor, when the nonmagnetic part is disposed near the coil conductor patterns of the magnetic layers, the DC application characteristics of inductance are greatly improved.

While preferred embodiments have been described above, variations thereto will occur to those skilled in the art within the scope of the present invention. The scope of the invention is therefore to be determined solely by the appended claims.

What is claimed is:

1. A multilayer inductor comprising:
a plurality of stacked magnetic layers;
through-holes formed in the stacked magnetic layers; and
a plurality of coil conductor patterns disposed between the plurality of magnetic layers and spirally connected to each other via the through-holes;
wherein the area of a projected plane of a circuit of each coil conductor pattern on a main surface of the magnetic layer is in a range from about 35% to about 75 of the area of the main surface of the magnetic layer.

2. A multilayer inductor according to claim 1, further comprising a nonmagnetic element disposed in the vicinity of the coil conductor patterns in the magnetic layer.

3. A multilayer inductor according to claim 1, further comprising external electrodes provided on the ends of the multilayer inductor.

4. A multilayer inductor according to claim 3, wherein the coil conductor patterns include lead out portions which are connected to respective ones of the external electrodes.

5. A multilayer inductor according to claim 1, wherein the magnetic layers are substantially disk-shaped.

6. A multilayer inductor according to claim 1, wherein the projected plane of the circuit of the coil conductor patterns on the main surfaces of the magnetic layers is substantially ring-shaped.

7. A multilayer inductor according to claim 1, wherein an air gap or a cavity is disposed inside one of the plurality of coil conductor patterns.

8. A multilayer inductor according to claim 1, wherein selected ones of the plurality of coil conductor patterns have substantially C-shaped configurations.

9. A multilayer inductor according to claim 1, wherein selected ones of the plurality of coil conductor patterns have substantially J-shaped configurations.
